(19) United States
(12) Patent Application Publication
(10) Pub. No.: US 2026/0329085 A1
(43) Pub. Date: Oct. 22, 2026

(54) AR HEAD-MOUNTED DISPLAY DEVICE, CONTROL METHOD AND CONTROL APPARATUS

(71) Applicant: Beijing Zitiao Network Technology Co., Ltd., Beijing (CN)

(72) Inventor: Ziying ZHANG, Beijing (CN)

(21) Appl. No.: 18/994,488

(22) PCT Filed: Aug. 18, 2023
(86) PCT No.: PCT/CN2023/113724

§ 371 Date: Jan. 14, 2025

(30) Foreign Application Priority Data
Aug. 18, 2022 (CN) 202210992832.0

(51) Int. Cl. G02B 27/01; G02F 1/17

(52) U.S. Cl. CPC G02B 27/0172; G02F 1/17

(57) ABSTRACT

The present disclosure relates to an AR head-mounted display device, a control method, and a control apparatus. The display device comprises: a display module, a lens, and a processor, wherein: the lens comprises an optical waveguide structure and a light shielding structure that are stacked; the light shielding structure is located on an ambient side of the optical waveguide structure away from eyes of a user; the optical waveguide structure is configured to couple light emitted from the display module to the eyes of the user; working states of the light shielding structure comprise a light shielding state and a light transmitting state; and the processor is electrically connected to the light shielding structure, and configured to control the light shielding structure to switch between the light shielding state and the light transmitting state.

### CROSS-REFERENCE TO RELATED APPLICATIONS

The present application is based on and claims priority to Chinese Application No. 202210992832.0, filed on Aug. 18, 2022, the disclosure of which is hereby incorporated by reference in its entirety.

### TECHNICAL FIELD

The present disclosure relates to the field of head-mounted display devices, and in particular, to an AR head-mounted display device, a control method, and a control apparatus.

### BACKGROUND

Augmented reality (AR) is a virtual-real combination technology. The so-called “virtual” refers to a virtual image, which is displayed by a micro display and amplified and transmitted by an optical element to reach the human eye. The so-called “real” refers to a real environment. The augmented reality technology is a technology of superimposing a virtual image on the real world.

Currently, since a head-mounted augmented reality display device does not need to be held and has a feature of freeing both hands, it is a main development direction of the current augmented reality technology.

Types of the head-mounted augmented reality display apparatuses comprise an optical see-through type and a video see-through type. The optical see-through type allows the human eye to directly receive light of a light transmitting adapter to see the real world, and at the same time, can also see the virtual image superimposed on the real world, which is the mainstream of the development of the augmented reality display technology.

### SUMMARY

In a first aspect, the present disclosure provides an AR head-mounted display device, comprising: a display module, a lens, and a processor, wherein:
the lens comprises a light waveguide structure and a light shielding structure that are stacked;
the light shielding structure is located on an ambient side of the optical waveguide structure away from eyes of a user;
the light waveguide structure is configured to couple light emitted from the display module to the eyes of the user;
working states of the light shielding structure comprises a light shielding state and a light transmitting state; and
the processor is electrically connected to the light shielding structure, and is configured to control the light shielding structure to switch between the light shielding state and the light transmitting state.

In a second aspect, the present disclosure further provides a control method of an AR head-mounted display device, where the control method is applicable to the AR head-mounted display device provided in the first aspect, display time of one frame of the AR head-mounted display device comprises at least one light transmitting period and at least one non-light transmitting period, and the light transmitting period and the non-light transmitting period are performed alternately, and the control method comprises:
controlling, in the light transmitting period, the display module not to display a virtual image, and the light shielding structure to be in a light transmitting state; and
Controlling, in the non-light transmitting period, the display module to display the virtual image, and the light shielding structure to be in a light shielding state.

In a third aspect, the present disclosure further provides a control apparatus of an AR head-mounted display device, where the control apparatus is applicable to the AR head-mounted display device provided in the first aspect, display time of one frame of the AR head-mounted display device comprises at least one light transmitting period and at least one non-light transmitting period, and the light transmitting period and the non-light transmitting period are performed alternately, and the control apparatus comprises:
a first control module, configured to control, in the light transmitting period, the display module not to display a virtual image, and the light shielding structure to be in a light transmitting state; and
a second control module, configured to control, in the non-light transmitting period, the display module to display the virtual image, and the light shielding structure to be in a light shielding state.

In a fourth aspect, the present disclosure further provides an electronic device, where the electronic device comprises:
one or more processors; and
a storage apparatus, configured to store one or more programs, wherein
the one or more programs, when executed by the one or more processors, cause the one or more processors to implement the control method of the AR head-mounted display device described above.

In a fifth aspect, the present disclosure further provides a computer-readable storage medium having a computer program stored thereon, where the program, when executed by a processor, causes the processor to implement the control method of the AR head-mounted display device described above.

In a sixth aspect, the present disclosure further provides a computer program, comprising: instructions that, when executed by a processor, cause the processor to implement the control method of the AR head-mounted display device described above.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

In order to more clearly illustrate the technical solutions in the embodiments of the present disclosure or in the prior art, the accompanying drawings for describing the embodiments or the prior art will be briefly described below. It is clear that the accompanying drawings in the following description show merely some embodiments of the present disclosure, and a person of ordinary skill in the art may still derive other drawings from these accompanying drawings without creative efforts.

FIG. 1 is a schematic structural diagram of an AR head-mounted display device according to some embodiments of the present disclosure;

FIG. 2 is a timing diagram of a working process of the AR head-mounted display device applicable to FIG. 1;

FIG. 3 is a schematic structural diagram of an AR head-mounted display device according to some embodiments of the present disclosure;

FIG. 4 is a schematic structural diagram of a phase retardation device in FIG. 3;

FIG. 5 is a timing diagram of a working process of an AR head-mounted display device according to some embodiments of the present disclosure;

FIG. 6 is a timing diagram of a working process of an AR head-mounted display device according to some embodiments of the present disclosure;

FIG. 7 is a schematic structural diagram of another AR headband-type display device according to some embodiments of the present disclosure;

FIG. 8 is a flowchart of a control method of an AR head-mounted display device according to some embodiments of the present disclosure;

FIG. 9 is a schematic structural diagram of a control apparatus of an AR head-mounted display device according to some embodiments of the present disclosure; and

FIG. 10 is a schematic structural diagram of an electronic device according to some embodiments of the present disclosure.

### DETAILED DESCRIPTION

In order to more clearly understand the above objects, features, and advantages of the present disclosure, the solutions of the present disclosure will be further described below. It should be noted that, in the case of no conflict, the embodiments of the present disclosure and the features in the embodiments may be combined with each other.

A lot of specific details are set forth in the following description to fully understand the present disclosure, but the present disclosure may also be implemented in other manners different from those described herein; apparently, the embodiments in the specification are merely some embodiments of the present disclosure, rather than all of the embodiments.

The inventor have found that the current optical see-through augmented reality display apparatus has a part of light emitted to the outside, and there is a light leakage phenomenon and a risk of information leakage. To solve the above technical problem or at least partially solve the above technical problem, the present disclosure provides an AR head-mounted display device, a control method, and a control apparatus.

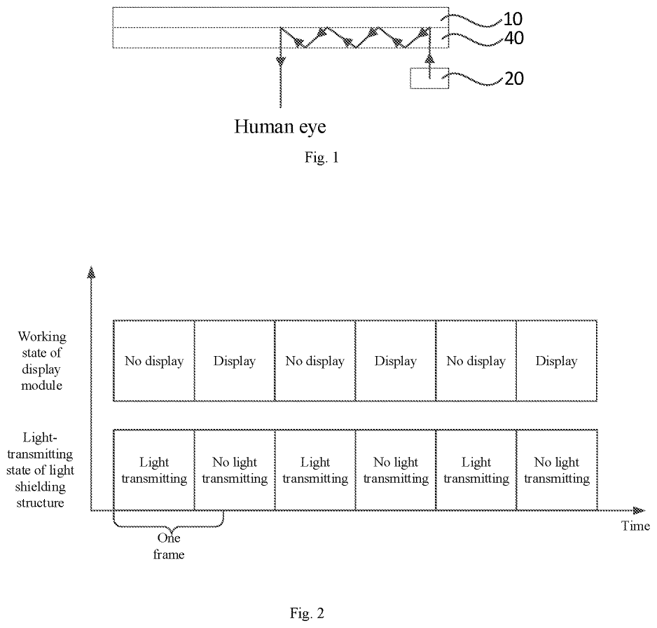

FIG. 1 is a schematic structural diagram of an AR head-mounted display device according to some embodiments of the present disclosure. Referring to FIG. 1, the AR head-mounted display device comprises: a display module 20, a lens, and a processor (not shown in the figure). The lens comprises a light waveguide structure 40 and a light shielding structure 10 that are stacked. The light shielding structure 10 is located on an ambient side of the light waveguide structure 40 away from eyes of a user (that is, a wearer of the AR head-mounted display device). The light waveguide structure 40 is configured to couple light emitted from the display module to the eyes of the user (that is, the wearer of the AR head-mounted display device). In FIG. 1, a propagation path of the light emitted from the display module when the display module 20 displays a virtual image is depicted by using a line with an arrow. An working state of the light shielding structure 10 comprises a light shielding state and a light transmitting state. The processor is electrically connected to the light shielding structure 10, and is configured to control the light shielding structure 10 to switch between the light shielding state and the light transmitting state.

When the user wears the AR head-mounted display device, a side close to the eyes of the user is an eye side, and a side away from the eyes of the user is an ambient side.

The light shielding structure 10 has different light shielding effects in the light shielding state and the light transmitting state. If the light shielding structure is in the light shielding state, the user cannot observe the real world through the light shielding structure. If the light shielding structure is in the light transmitting state, the user can observe the real world through the light shielding structure. In an embodiment, the light shielding effect of the light shielding structure is adjusted by adjusting the light transmittance of the light shielding structure.

In some embodiments, the processor is configured to control the light shielding structure 10 to be in the light transmitting state when the display module 20 does not display a virtual image, and control the light shielding structure 10 to be in the light shielding state when the display module 20 displays a virtual image.

When the display module does not display a virtual image, a visual image of the real world formed in the human eyes will not be disturbed by the virtual image displayed by the display module, so that the visual image of the real world is very clear in the human brain. In addition, other users (who are not the wearer of the AR head-mounted display device) cannot observe the virtual image displayed by the display module through the light shielding structure. When the light shielding structure is in the light shielding state, a visual image of a virtual image formed in the human eyes will not be disturbed by external ambient light, so that the virtual image has high visibility, and the visual image of the virtual image can be very clear in the human brain. In addition, light forming the virtual image cannot reach the eyes of other users (who are not the wearer of the AR head-mounted display device) through the light shielding structure, to avoid an adverse phenomenon of information leakage.

FIG. 2 is a timing diagram of a working process of an AR head-mounted display device applicable to FIG. 1. On the basis of the above technical solution, in some embodiments, referring to FIG. 2, display time of one frame of the AR head-mounted display device comprises at least one light transmitting period and at least one non-light transmitting period, and the light transmitting period and the non-light transmitting period are performed alternately. In the light transmitting period, the display module does not display a virtual image, and the light shielding structure is in the light transmitting state. In the non-light transmitting period, the display module displays the virtual image, and the light shielding structure is in the light shielding state.

Human vision has the characteristic of visual persistence. Specifically, visual persistence refers to a phenomenon in which the vision generated by light on the retina is still retained for a period of time after the light stops acting. Referring to FIG. 2, in some embodiments, the display time of one frame comprises one light transmitting period and one non-light transmitting period. In the light transmitting period, since the light shielding structure is in the light transmitting state, the human eyes can observe the real world through the light shielding structure. Due to the effect of visual persistence, when the time reaches the non-light transmitting period, the visual image of the real world is still retained in the human brain. At the same time, in the non-light transmitting period, the display module displays the virtual image, and the human eyes can also see the virtual image displayed by the display module. The visual image formed by the virtual image is also retained in the human brain, so that the virtual image and the real world are superimposed in human perception.

When the display module does not display the virtual image in the light transmitting period, a visual image of the real world formed in the human eyes will not be disturbed by the virtual image displayed by the display module, so that the visual image of the real world is clearer in the human brain. In addition, other users (who are not the wearer of the AR head-mounted display device) cannot observe the virtual image displayed by the display module through the light shielding structure. In the non-light transmitting period, the light shielding structure is in the light shielding state, a visual image of the virtual image formed in the human eyes will not be disturbed by external ambient light, so that the virtual image has high visibility, and the visual image of the virtual image can be clearer in the human brain. In addition, light forming the virtual image cannot reach the eyes of other users (who are not the wearer of the AR head-mounted display device) through the light shielding structure, to avoid an adverse phenomenon of information leakage.

Therefore, the above technical solution can improve visibility of the virtual image and the real world on the one hand, and can avoid the adverse phenomenon of the information leakage caused by light for forming the virtual image being emitted to the outside on the other hand.

In the above technical solution, a first period in the display time of one frame is the light transmitting period, which is only a specific example of the present application, rather than a limitation on the present application. In practice, in the display time of one frame, the first period may also be the non-light transmitting period.

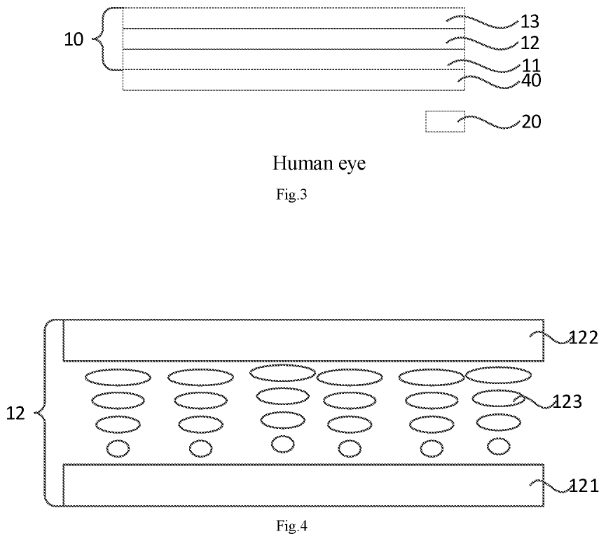

There are various specific setting manners of the light shielding structure, which are not limited in the present application. FIG. 3 is a schematic structural diagram of an AR head-mounted display device according to some embodiments of the present disclosure. Referring to FIG. 3, the light shielding structure comprises a first polarization optical element 11, a phase retardation device 12, and a second polarization optical element 13 that are stacked in a direction from an eye side to an ambient side.

In some embodiments, both the first polarization optical element 11 and the second polarization optical element 13 are polarizers. Alternatively, both the first polarization optical element 11 and the second polarization optical element 13 are polarization light splitting films. Alternatively, the first polarization optical element 11 is a polarization light splitting film, and the second polarization optical element 13 is a polarizer. Alternatively, the first polarization optical element 11 is a polarizer, and the second polarization optical element 13 is a polarization light splitting film. The polarization light splitting film may reflect light vibrating in a first direction, and at the same time transmit light vibrating in a second direction, where the first direction is perpendicular to the second direction. In some embodiments, the polarization light splitting film is a metal wire grid film or the like.

In some embodiments, polarization directions of the first polarization optical element and the second polarization optical element are parallel or perpendicular.

The phase retardation refers to a phenomenon of phase delay caused by deflection of a phase of light when the light passes through a substance with dichroism or polydirectionality. The phase retardation device refers to a device comprising a substance with dichroism or polydirectionality. In some embodiments, the phase retardation device is a liquid crystal device.

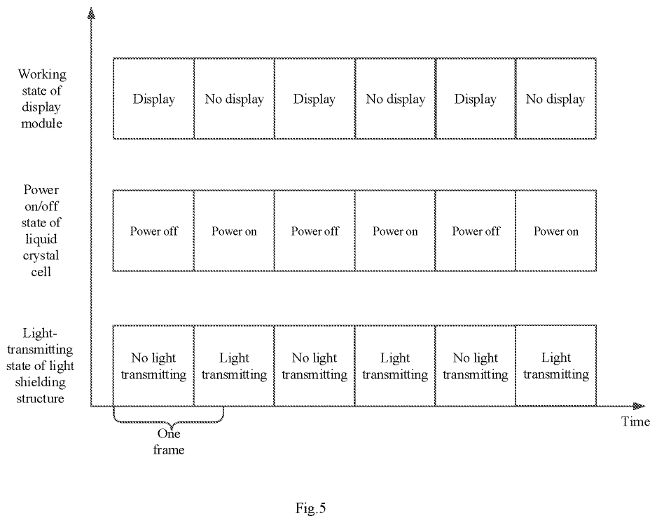

FIG. 4 is a schematic structural diagram of the phase retardation device in FIG. 3. Referring to FIG. 4, the phase retardation device comprises an upper substrate 122 and a lower substrate 121, and liquid crystals 123 are filled between the upper substrate 122 and the lower substrate 121. A first electrode (not shown in FIG. 4) is disposed on the upper substrate 122, and a second electrode (not shown in FIG. 4) is disposed on the lower substrate 121. A first driving voltage signal is input to the first electrode, and a second driving voltage signal is input to the second electrode, so that a voltage difference is formed between the first electrode and the second electrode, thereby forming an electric field. Because liquid crystal molecules have optical activity, compared with a case without an electric field, the liquid crystal molecules flip under the action of the electric field, which changes a polarization direction of polarized light irradiated on the liquid crystal molecules.

The specific structure and principle of the light shielding structure are described in detail below with reference to specific examples.

### Example 1

Referring to FIG. 3, if both the first polarization optical element 11 and the second polarization optical element 13 are polarizers, and a light transmitting axis of the first polarization optical element 11 is parallel to a light transmitting axis of the second polarization optical element 13, the phase retardation device 12 rotates a polarization direction of light irradiated thereon by 90° in a power-off state, and does not rotate the polarization direction of light irradiated thereon in a power-on state.

When the phase retardation device 12 is in the power-off state, external light becomes linearly polarized light with a vibration direction parallel to a light transmitting axis of the second polarization optical element 13 after passing through the second polarization optical element 13. After passing through the phase retardation device 12, a polarization direction of the linearly polarized light rotates by 90° and then reaches the first polarization optical element 11. Because a vibration direction of the linearly polarized light reaching the first polarization optical element 11 is perpendicular to the light transmitting axis of the first polarization optical element 11, the linearly polarized light is absorbed by the first polarization optical element 11. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light rotates by 90° and then reaches the second polarization optical element 13. Because a vibration direction of the linearly polarized light reaching the second polarization optical element 13 is perpendicular to the light transmitting axis of the second polarization optical element 13, the linearly polarized light is absorbed by the second polarization optical element 13. That is, when the phase retardation device 12 is powered off, the external light cannot pass through the light shielding structure 10, and the leaked light of the augmented reality display module cannot pass through the light shielding structure 10 either.

When the phase retardation device 12 is in the powered-on state, external light becomes linearly polarized light with a vibration direction parallel to a light transmitting axis of the second polarization optical element 13 after passing through the second polarization optical element 13. After passing through the phase retardation device 12, a polarization direction of the linearly polarized light does not rotate and then reaches the first polarization optical element 11. Because a vibration direction of the linearly polarized light reaching the first polarization optical element 11 is parallel to the light transmitting axis of the first polarization optical element 11, the linearly polarized light can pass through the first polarization optical element 11. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light does not rotate and then reaches the second polarization optical element 13. Because a vibration direction of the linearly polarized light reaching the second polarization optical element 13 is parallel to the light transmitting axis of the second polarization optical element 13, the linearly polarized light can pass through the second polarization optical element 13. That is, when the phase retardation device 12 is powered on, the external light can pass through the light shielding structure 10, and the leaked light of the augmented reality display module can also pass through the light shielding structure 10.

FIG. 5 is a timing diagram of a working process of an AR head-mounted display device according to some embodiments of the present disclosure. Referring to FIG. 5, within display time of one frame, in the non-light transmitting period, the display module is controlled to be in a bright state to display a virtual image, and the phase retardation device in the light shielding structure is controlled to be powered off. In this case, leaked light of the augmented reality display module cannot pass through the light shielding structure, and the leaked light of the augmented reality display module cannot be seen in the outside world. In the light transmitting period, the display module is controlled to be in a dark state and cannot display a virtual image, and the phase retardation device in the light shielding structure is controlled to be powered on. In this case, the light shielding structure is light transmitting, and a wearer can perceive external light in this period, and can observe the real world through the light shielding structure. However, at this time, the augmented reality display module is in the dark state and does not emit leaked light. In this way, leaked light is blocked, and external light is transmitted, so that visibility of the virtual image and the real world can be improved on the one hand, and an adverse phenomenon of information leakage caused by light for forming the virtual image being emitted to the outside can be avoided on the other hand.

### Example 2

Referring to FIG. 3, if both the first polarization optical element 11 and the second polarization optical element 13 are polarizers, and a light transmitting axis of the first polarization optical element 11 is perpendicular to a light transmitting axis of the second polarization optical element 13, the phase retardation device 12 rotates a polarization direction of light irradiated thereon by 90° in a power-off state, and does not rotate a polarization direction of light irradiated thereon in a power-on state.

When the phase retardation device 12 is in the power-off state, external light becomes linearly polarized light with a vibration direction parallel to a light transmitting axis of the second polarization optical element 13 after passing through the second polarization optical element 13. After passing through the phase retardation device 12, a polarization direction of the linearly polarized light rotates by 90° and then reaches the first polarization optical element 11. Because a vibration direction of the linearly polarized light reaching the first polarization optical element 11 is parallel to the light transmitting axis of the first polarization optical element 11, the linearly polarized light can pass through the first polarization optical element 11. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light rotates by 90° and then reaches the second polarization optical element 13. Because a vibration direction of the linearly polarized light reaching the second polarization optical element 13 is parallel to the light transmitting axis of the second polarization optical element 13, the linearly polarized light can pass through the second polarization optical element 13. That is, when the phase retardation device 12 is powered off, the external light can pass through the light shielding structure 10, and the leaked light of the augmented reality display module can also pass through the light shielding structure 10.

When the phase retardation device 12 is in the powered-on state, external light becomes linearly polarized light with a vibration direction parallel to a light transmitting axis of the second polarization optical element 13 after passing through the second polarization optical element 13. After passing through the phase retardation device 12, a polarization direction of the linearly polarized light does not rotate and then reaches the first polarization optical element 11. Because a vibration direction of the linearly polarized light reaching the first polarization optical element 11 is perpendicular to the light transmitting axis of the first polarization optical element 11, the linearly polarized light is absorbed by the first polarization optical element 11. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light does not rotate and then reaches the second polarization optical element 13. Because a vibration direction of the linearly polarized light reaching the second polarization optical element 13 is perpendicular to the light transmitting axis of the second polarization optical element 13, the linearly polarized light is absorbed by the second polarization optical element 13. That is, when the phase retardation device 12 is powered on, the external light cannot pass through the light shielding structure 10, and the leaked light of the augmented reality display module cannot pass through the light shielding structure 10 either.

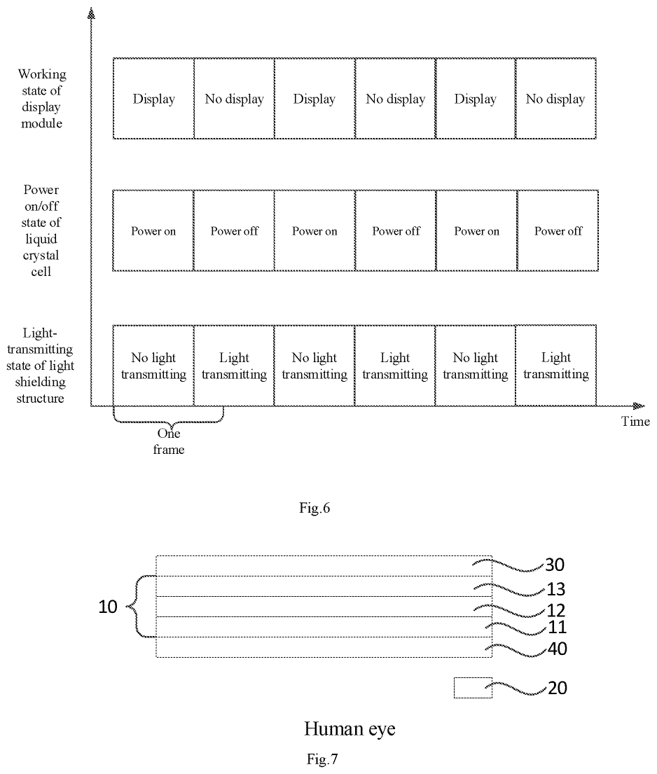

FIG. 6 is a timing diagram of a working process of an AR head-mounted display device according to some embodiments of the present disclosure. Referring to FIG. 6, within display time of one frame, in the non-light transmitting period, the display module is controlled to be in a bright state to display a virtual image, and the phase retardation device in the light shielding structure is controlled to be powered on. In this case, leaked light of the augmented reality display module cannot pass through the light shielding structure, and the leaked light of the augmented reality display module cannot be seen in the outside world. In the light transmitting period, the display module is controlled to be in a dark state and cannot display a virtual image, and the phase retardation device in the light shielding structure is controlled to be powered off. In this case, the light shielding structure is light transmitting, and a wearer can perceive external light in this period, and can observe the real world through the light shielding structure. However, at this time, the augmented reality display module is in the dark state and does not emit leaked light. In this way, leaked light is blocked, and external light is transmitted, so that visibility of the virtual image and the real world can be improved on the one hand, and an adverse phenomenon of information leakage caused by light for forming the virtual image being emitted to the outside can be avoided on the other hand.

### Example 3

Referring to FIG. 3, if both the first polarization optical element 11 and the second polarization optical element 13 are polarizers, and a light transmitting axis of the first polarization optical element 11 is parallel to a light transmitting axis of the second polarization optical element 13, the phase retardation device 12 rotates a polarization direction of light irradiated thereon by 90° in a power-on state, and does not rotate a polarization direction of light irradiated thereon in a power-off state.

When the phase retardation device 12 is in a powered-on state, external light becomes linearly polarized light with a vibration direction parallel to a light transmitting axis of the second polarization optical element 13 after passing through the second polarization optical element 13. After passing through the phase retardation device 12, a polarization direction of the linearly polarized light rotates by 90° and then reaches the first polarization optical element 11. Because a vibration direction of the linearly polarized light reaching the first polarization optical element 11 is perpendicular to the light transmitting axis of the first polarization optical element 11, the linearly polarized light is absorbed by the first polarization optical element 11. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light rotates by 90° and then reaches the second polarization optical element 13. Because a vibration direction of the linearly polarized light reaching the second polarization optical element 13 is perpendicular to the light transmitting axis of the second polarization optical element 13, the linearly polarized light is absorbed by the second polarization optical element 13. That is, when the phase retardation device 12 is powered on, the external light cannot pass through the light shielding structure 10, and the leaked light of the augmented reality display module cannot pass through the light shielding structure 10 either.

When the phase retardation device 12 is in the powered-off state, external light becomes linearly polarized light with a vibration direction parallel to a light transmitting axis of the second polarization optical element 13 after passing through the second polarization optical element 13. After passing through the phase retardation device 12, a polarization direction of the linearly polarized light does not rotate and then reaches the first polarization optical element 11. Because a vibration direction of the linearly polarized light reaching the first polarization optical element 11 is parallel to the light transmitting axis of the first polarization optical element 11, the linearly polarized light can pass through the first polarization optical element 11. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light does not rotate and then reaches the second polarization optical element 13. Because a vibration direction of the linearly polarized light reaching the second polarization optical element 13 is parallel to the light transmitting axis of the second polarization optical element 13, the linearly polarized light can pass through the second polarization optical element 13. That is, when the phase retardation device 12 is powered off, the external light can pass through the light shielding structure 10, and the leaked light of the augmented reality display module can also pass through the light shielding structure 10.

In this case, a timing diagram of a working process of the AR head-mounted display device is consistent with FIG. 6. Referring to FIG. 6, within display time of one frame, in the non-light transmitting period, the display module is controlled to be in a bright state to display a virtual image, and the phase retardation device in the light shielding structure is controlled to be powered on. In this case, the leaked light of the augmented reality display module cannot pass through the light shielding structure, and the leaked light of the augmented reality display module cannot be seen in the outside world. In the light transmitting period, the display module is controlled to be in a dark state and cannot display a virtual image, and the phase retardation device in the light shielding structure is controlled to be powered off. In this case, the light shielding structure is light transmitting, and a wearer can perceive the external light in this period, and can observe the real world through the light shielding structure. However, at this time, the augmented reality display module is in the dark state and does not emit the leaked light. In this way, the leaked light is blocked, and the external light is transmitted, so that visibility of the virtual image and the real world can be improved on the one hand, and an adverse phenomenon of information leakage caused by light for forming the virtual image being emitted to the outside can be avoided on the other hand.

### Example 4

Referring to FIG. 3, if both the first polarization optical element 11 and the second polarization optical element 13 are polarizers, and a light transmitting axis of the first polarization optical element 11 is perpendicular to a light transmitting axis of the second polarization optical element 13, the phase retardation device 12 rotates a polarization direction of light irradiated thereon by 90° in a power-on state, and does not rotate a polarization direction of light irradiated thereon in a power-off state.

When the phase retardation device 12 is in the powered-on state, external light becomes linearly polarized light with a vibration direction parallel to a light transmitting axis of the second polarization optical element 13 after passing through the second polarization optical element 13. After passing through the phase retardation device 12, a polarization direction of the linearly polarized light rotates by 90° and then reaches the first polarization optical element 11. Because a vibration direction of the linearly polarized light reaching the first polarization optical element 11 is parallel to the light transmitting axis of the first polarization optical element 11, the linearly polarized light can pass through the first polarization optical element 11. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light rotates by 90° and then reaches the second polarization optical element 13. Because a vibration direction of the linearly polarized light reaching the second polarization optical element 13 is parallel to the light transmitting axis of the second polarization optical element 13, the linearly polarized light can pass through the second polarization optical element 13. That is, when the phase retardation device 12 is powered on, the external light can pass through the light shielding structure 10, and the leaked light of the augmented reality display module can also pass through the light shielding structure 10.

When the phase retardation device 12 is in the powered-off state, external light becomes linearly polarized light with a vibration direction parallel to a light transmitting axis of the second polarization optical element 13 after passing through the second polarization optical element 13. After passing through the phase retardation device 12, a polarization direction of the linearly polarized light does not rotate and then reaches the first polarization optical element 11. Because a vibration direction of the linearly polarized light reaching the first polarization optical element 11 is perpendicular to the light transmitting axis of the first polarization optical element 11, the linearly polarized light is absorbed by the first polarization optical element 11. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light does not rotate and then reaches the second polarization optical element 13. Because a vibration direction of the linearly polarized light reaching the second polarization optical element 13 is perpendicular to the light transmitting axis of the second polarization optical element 13, the linearly polarized light is absorbed by the second polarization optical element 13. That is, when the phase retardation device 12 is powered off, the external light cannot pass through the light shielding structure 10, and the leaked light of the augmented reality display module cannot pass through the light shielding structure 10 either.

In this case, a timing diagram of a working process of the AR head-mounted display device is consistent with FIG. 5. Referring to FIG. 5, within display time of one frame, in the non-light transmitting period, the display module is controlled to be in a bright state to display a virtual image, and the phase retardation device in the light shielding structure is controlled to be powered off. In this case, the leaked light of the augmented reality display module cannot pass through the light shielding structure, and the leaked light of the augmented reality display module cannot be seen in the outside world. In the light transmitting period, the display module is controlled to be in a dark state and cannot display a virtual image, and the phase retardation device in the light shielding structure is controlled to be powered on. In this case, the light shielding structure is light transmitting, and a wearer can perceive external light in this period, and can observe the real world through the light shielding structure. However, at this time, the augmented reality display module is in the dark state and does not emit the leaked light. In this way, the leaked light is blocked, and the external light is transmitted, so that visibility of the virtual image and the real world can be improved on the one hand, and an adverse phenomenon of information leakage caused by light for forming the virtual image being emitted to the outside can be avoided on the other hand.

### Example 5

Referring to FIG. 3, if both the first polarization optical element 11 and the second polarization optical element 13 are polarization light splitting films, and a light transmitting axis of the first polarization optical element 11 is parallel to a light transmitting axis of the second polarization optical element 13, the phase retardation device 12 rotates a polarization direction of light irradiated thereon by 90° in a power-off state, and does not rotate a polarization direction of light irradiated thereon in a power-on state.

When the phase retardation device 12 is powered off, external light becomes linearly polarized light with a vibration direction parallel to a light transmitting axis of the second polarization optical element 13 after passing through the second polarization optical element 13. After passing through the phase retardation device 12, a polarization direction of the linearly polarized light rotates by 90° and then reaches the first polarization optical element 11. Because a vibration direction of the linearly polarized light reaching the first polarization optical element 11 is perpendicular to the light transmitting axis of the first polarization optical element 11, the linearly polarized light is reflected by the first polarization optical element 11 and reaches the phase retardation device 12 again. A polarization direction of light reaching the phase retardation device 12 again rotates by 90° and is restored to a direction parallel to the light transmitting axis of the second polarization optical element 13, and then passes through the second polarization optical element 13. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light rotates by 90° and then reaches the second polarization optical element 13. The linearly polarized light is reflected by the second polarization optical element 13 and reaches the phase retardation device 12 again. A polarization direction of light reaching the phase retardation device 12 again rotates by 90° and is restored to a direction parallel to the light transmitting axis of the first polarization optical element 11, and then passes through the first polarization optical element 11, reaches the human eyes through the lens, and is received by the human eyes. That is, when the phase retardation device 12 is powered off, the external light cannot pass through the light shielding structure 10, the leaked light of the augmented reality display module is reflected back and received by the human eyes, which can enhance brightness of the virtual image and improve light energy utilization of the augmented reality display module.

When the phase retardation device 12 is in the powered-on state, external light becomes linearly polarized light with a vibration direction parallel to a light transmitting axis of the second polarization optical element 13 after passing through the second polarization optical element 13. After passing through the phase retardation device 12, a polarization direction of the linearly polarized light does not rotate and then reaches the first polarization optical element 11. Because a vibration direction of the linearly polarized light reaching the first polarization optical element 11 is parallel to the light transmitting axis of the first polarization optical element 11, the linearly polarized light can pass through the first polarization optical element 11. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light does not rotate and then reaches the second polarization optical element 13. Because a vibration direction of the linearly polarized light reaching the second polarization optical element 13 is parallel to the light transmitting axis of the second polarization optical element 13, the linearly polarized light can pass through the second polarization optical element 13. That is, when the phase retardation device 12 is powered on, the external light can pass through the light shielding structure 10, and the leaked light of the augmented reality display module can also pass through the light shielding structure 10.

In this case, a timing diagram of a working process of the AR head-mounted display device is consistent with FIG. 5. Referring to FIG. 5, within display time of one frame, in the non-light transmitting period, the display module is controlled to be in a bright state to display a virtual image, and the phase retardation device in the light shielding structure is controlled to be powered off. In this case, the leaked light of the augmented reality display module cannot only pass through the light shielding structure, but also is reflected to the human eyes for use, and the leaked light of the augmented reality display module cannot be seen. In the light transmitting period, the display module is controlled to be in a dark state and cannot display a virtual image, and the phase retardation device in the light shielding structure is controlled to be powered on. In this case, the light shielding structure is light transmitting, and a wearer can perceive external light in this period, and can observe the real world through the light shielding structure. However, at this time, the augmented reality display module is in the dark state and does not emit the leaked light. In this way, the leaked light is blocked, and the external light is transmitted, so that visibility of the virtual image and the real world can be improved on the one hand, and an adverse phenomenon of information leakage caused by light for forming the virtual image being emitted to the outside can be avoided on the other hand.

### Example 6

Referring to FIG. 3, if both the first polarization optical element 11 and the second polarization optical element 13 are polarization light splitting films, and a light transmitting axis of the first polarization optical element 11 is perpendicular to a light transmitting axis of the second polarization optical element 13, the phase retardation device 12 rotates a polarization direction of light irradiated thereon by 90° in a power-off state, and does not rotate a polarization direction of light irradiated thereon in a power-on state.

When the phase retardation device 12 is in the powered-off state, external light becomes linearly polarized light with a vibration direction parallel to a light transmitting axis of the second polarization optical element 13 after passing through the second polarization optical element 13. After passing through the phase retardation device 12, a polarization direction of the linearly polarized light rotates by 90° and then reaches the first polarization optical element 11. Because a vibration direction of the linearly polarized light reaching the first polarization optical element 11 is parallel to the light transmitting axis of the first polarization optical element 11, the linearly polarized light can pass through the first polarization optical element 11. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light rotates by 90° and then reaches the second polarization optical element 13. Because a vibration direction of the linearly polarized light reaching the second polarization optical element 13 is parallel to the light transmitting axis of the second polarization optical element 13, the linearly polarized light can pass through the second polarization optical element 13. That is, when the phase retardation device 12 is powered off, the external light can pass through the light shielding structure 10, and the leaked light of the augmented reality display module can also pass through the light shielding structure 10.

When the phase retardation device 12 is in the powered-on state, external light becomes linearly polarized light with a vibration direction parallel to a light transmitting axis of the second polarization optical element 13 after passing through the second polarization optical element 13. After passing through the phase retardation device 12, a polarization direction of the linearly polarized light does not rotate and then reaches the first polarization optical element 11. Because a vibration direction of the linearly polarized light reaching the first polarization optical element 11 is perpendicular to the light transmitting axis of the first polarization optical element 11, the linearly polarized light is reflected by the first polarization optical element 11 and reaches the phase retardation device 12 again. A polarization direction of light reaching the phase retardation device 12 again rotates by 90° and is restored to a direction parallel to the light transmitting axis of the second polarization optical element 13, and then passes through the second polarization optical element 13. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light does not rotate and then reaches the second polarization optical element 13. The linearly polarized light is reflected by the second polarization optical element 13 and reaches the phase retardation device 12 again. A polarization direction of light reaching the phase retardation device 12 again rotates by 90° and is restored to a direction parallel to the light transmitting axis of the first polarization optical element 11, and then passes through the first polarization optical element 11, reaches the human eyes through the lens, and is received by the human eyes. That is, when the phase retardation device 12 is powered on, the external light cannot pass through the light shielding structure 10, the leaked light of the augmented reality display module is reflected back and received by the human eyes, which can enhance brightness of the virtual image and improve light energy utilization of the augmented reality display module.

In this case, a timing diagram of a working process of the AR head-mounted display device is consistent with FIG. 6. Referring to FIG. 6, within display time of one frame, in the non-light transmitting period, the display module is controlled to be in a bright state to display a virtual image, and the phase retardation device in the light shielding structure is controlled to be powered on. In this case, the leaked light of the augmented reality display module cannot only pass through the light shielding structure, but also is reflected to the human eyes for use, and the leaked light of the augmented reality display module cannot be seen in the outside world. In the light transmitting period, the display module is controlled to be in a dark state and cannot display a virtual image, and the phase retardation device in the light shielding structure is controlled to be powered off. In this case, the light shielding structure is light transmitting, and a wearer can perceive external light in this period, and can observe the real world through the light shielding structure. However, at this time, the augmented reality display module is in the dark state and does not emit the leaked light. In this way, the leaked light is blocked, and the external light is transmitted, so that visibility of the virtual image and the real world can be improved on the one hand, and an adverse phenomenon of information leakage caused by light for forming the virtual image being emitted to the outside can be avoided on the other hand.

### Example 7

Referring to FIG. 3, if both the first polarization optical element 11 and the second polarization optical element 13 are polarization light splitting films, and a light transmitting axis of the first polarization optical element 11 is parallel to a light transmitting axis of the second polarization optical element 13, the phase retardation device 12 rotates a polarization direction of light irradiated thereon by 90° in a power-on state, and does not rotate a polarization direction of light irradiated thereon in a power-off state.

When the phase retardation device 12 is in the powered-on state, external light becomes linearly polarized light with a vibration direction parallel to a light transmitting axis of the second polarization optical element 13 after passing through the second polarization optical element 13. After passing through the phase retardation device 12, a polarization direction of the linearly polarized light rotates by 90° and then reaches the first polarization optical element 11. Because a vibration direction of the linearly polarized light reaching the first polarization optical element 11 is perpendicular to the light transmitting axis of the first polarization optical element 11, the linearly polarized light is reflected by the first polarization optical element 11 and reaches the phase retardation device 12 again. A polarization direction of light reaching the phase retardation device 12 again rotates by 90° and is restored to a direction parallel to the light transmitting axis of the second polarization optical element 13, and then passes through the second polarization optical element 13. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light rotates by 90° and then reaches the second polarization optical element 13. Because a vibration direction of the linearly polarized light reaching the second polarization optical element 13 is perpendicular to the light transmitting axis of the second polarization optical element 13, the linearly polarized light is reflected by the second polarization optical element 13 and reaches the phase retardation device 12 again. A polarization direction of light reaching the phase retardation device 12 again rotates by 90° and is restored to a direction parallel to the light transmitting axis of the first polarization optical element 11, and then passes through the first polarization optical element 11, reaches the human eyes through the lens, and is received by the human eyes. That is, when the phase retardation device 12 is powered on, the external light cannot pass through the light shielding structure 10, the leaked light of the augmented reality display module is reflected back and received by the human eyes, which can enhance brightness of the virtual image and improve light energy utilization of the augmented reality display module.

When the phase retardation device 12 is in the powered-off state, external light becomes linearly polarized light with a vibration direction parallel to a light transmitting axis of the second polarization optical element 13 after passing through the second polarization optical element 13. After passing through the phase retardation device 12, a polarization direction of the linearly polarized light does not rotate and then reaches the first polarization optical element 11. Because a vibration direction of the linearly polarized light reaching the first polarization optical element 11 is parallel to the light transmitting axis of the first polarization optical element 11, the linearly polarized light can pass through the first polarization optical element 11. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light does not rotate and then reaches the second polarization optical element 13. Because a vibration direction of the linearly polarized light reaching the second polarization optical element 13 is parallel to the light transmitting axis of the second polarization optical element 13, the linearly polarized light can pass through the second polarization optical element 13. That is, when the phase retardation device 12 is powered off, the external light can pass through the light shielding structure 10, and the leaked light of the augmented reality display module can also pass through the light shielding structure 10.

In this case, a timing diagram of a working process of the AR head-mounted display device is consistent with FIG. 6. Referring to FIG. 6, within display time of one frame, in the non-light transmitting period, the display module is controlled to be in a bright state to display a virtual image, and the phase retardation device in the light shielding structure is controlled to be powered on. In this case, the leaked light of the augmented reality display module cannot only pass through the light shielding structure, but also is reflected to the human eyes for use, and the leaked light of the augmented reality display module cannot be seen in the outside world. In the light transmitting period, the display module is controlled to be in a dark state and cannot display a virtual image, and the phase retardation device in the light shielding structure is controlled to be powered off. In this case, the light shielding structure is light transmitting, and a wearer can perceive external light in this period, and can observe the real world through the light shielding structure. However, at this time, the augmented reality display module is in the dark state and does not emit the leaked light. In this way, the leaked light is blocked, and external light is transmitted, so that visibility of the virtual image and the real world can be improved on the one hand, and an adverse phenomenon of information leakage caused by light for forming the virtual image being emitted to the outside can be avoided on the other hand.

### Example 8

Referring to FIG. 3, if both the first polarization optical element 11 and the second polarization optical element 13 are polarization light splitting films, and a light transmitting axis of the first polarization optical element 11 is perpendicular to a light transmitting axis of the second polarization optical element 13, the phase retardation device 12 rotates a polarization direction of light irradiated thereon by 90° in a power-on state, and does not rotate a polarization direction of light irradiated thereon in a power-off state.

When the phase retardation device 12 is in the powered-on state, external light becomes linearly polarized light with a vibration direction parallel to a light transmitting axis of the second polarization optical element 13 after passing through the second polarization optical element 13. After passing through the phase retardation device 12, a polarization direction of the linearly polarized light rotates by 90° and then reaches the first polarization optical element 11. Because a vibration direction of the linearly polarized light reaching the first polarization optical element 11 is parallel to the light transmitting axis of the first polarization optical element 11, the linearly polarized light can pass through the first polarization optical element 11. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light rotates by 90° and then reaches the second polarization optical element 13. Because a vibration direction of the linearly polarized light reaching the second polarization optical element 13 is parallel to the light transmitting axis of the second polarization optical element 13, the linearly polarized light can pass through the second polarization optical element 13. That is, when the phase retardation device 12 is powered on, the external light can pass through the light shielding structure 10, and the leaked light of the augmented reality display module can also pass through the light shielding structure 10.

When the phase retardation device 12 is in the powered-off state, external light becomes linearly polarized light with a vibration direction parallel to a light transmitting axis of the second polarization optical element 13 after passing through the second polarization optical element 13. After passing through the phase retardation device 12, a polarization direction of the linearly polarized light does not rotate and then reaches the first polarization optical element 11. Because a vibration direction of the linearly polarized light reaching the first polarization optical element 11 is perpendicular to the light transmitting axis of the first polarization optical element 11, the linearly polarized light is reflected by the first polarization optical element 11 and reaches the phase retardation device 12 again. A polarization direction of light reaching the phase retardation device 12 again rotates by 90° and is restored to a direction parallel to the light transmitting axis of the second polarization optical element 13, and then passes through the second polarization optical element 13. If the augmented reality display module displays a virtual image, leaked light of the augmented reality display module becomes linearly polarized light with a vibration direction parallel to the light transmitting axis of the first polarization optical element 11 after passing through the first polarization optical element 11. After passing through the phase retardation device 12, a polarization direction of the linearly polarized light does not rotate and then reaches the second polarization optical element 13. Because a vibration direction of the linearly polarized light reaching the second polarization optical element 13 is perpendicular to the light transmitting axis of the second polarization optical element 13, the linearly polarized light is reflected by the second polarization optical element 13 and reaches the phase retardation device 12 again. A polarization direction of light reaching the phase retardation device 12 again rotates by 90° and is restored to a direction parallel to the light transmitting axis of the first polarization optical element 11, and then passes through the first polarization optical element 11, reaches the human eyes through the lens, and is received by the human eyes. That is, when the phase retardation device 12 is powered off, the external light cannot pass through the light shielding structure 10, the leaked light of the augmented reality display module cannot pass through the light shielding structure 10 either, but is reflected back and received by the human eyes, which can enhance brightness of the virtual image and improve light energy utilization of the augmented reality display module.

In this case, a timing diagram of a working process of the AR head-mounted display device is consistent with FIG. 5. Referring to FIG. 5, within display time of one frame, in the non-light transmitting period, the display module is controlled to be in a bright state to display a virtual image, and the phase retardation device in the light shielding structure is controlled to be powered off. In this case, the leaked light of the augmented reality display module cannot only pass through the light shielding structure, but also is reflected to the human eyes for use, and the leaked light of the augmented reality display module cannot be seen in the outside world. In the light transmitting period, the display module is controlled to be in a dark state and cannot display a virtual image, and the phase retardation device in the light shielding structure is controlled to be powered on. In this case, the light shielding structure is light transmitting, and a wearer can perceive external light in this period, and can observe the real world through the light shielding structure. However, at this time, the augmented reality display module is in the dark state and does not emit the leaked light. In this way, the leaked light is blocked, and external light is transmitted, so that visibility of the virtual image and the real world can be improved on the one hand, and an adverse phenomenon of information leakage caused by light for forming the virtual image being emitted to the outside can be avoided on the other hand.

It should be noted that the optical waveguide structure in the foregoing lens may be a waveguide lens. In practice, the waveguide lens may alternatively be replaced with a Birdbath lens or a prism lens. However, when at least one of the first polarization optical element and the second polarization optical element is a polarization light splitting film, if another lens, for example, a Birdbath lens or a prism lens, is used, leaked light of the display module is reflected at the polarization light splitting film and then forms an image. The formed image has aberration from an image directly incident to the human eyes, and thus the virtual image is not clear. However, this problem does not occur when the waveguide lens is used.

In some embodiments, the light shielding structure comprises a plurality of light shielding units arranged in an array, and a working state of each light shielding unit is independently adjustable; in the light transmitting period, a light shielding unit in the light shielding structure that is located in a target area is in a non-light transmitting state, and a light shielding unit that is located outside the target area is in a light transmitting state; where the target area is a display area of the display module on the lens.

“A working state of each light shielding unit is independently adjustable” means that a working state of each light shielding unit can be separately adjusted, for example, the working state is controlled to be adjusted from a light transmitting state to a light shielding state, or from the light shielding state to the light transmitting state.

In some embodiments, the target area is a projection area of a target object on the light shielding structure, and the target object is an object comprised in a virtual image displayed by the display module in the non-light transmitting period in a same frame.

The virtual image displayed by the display module comprises at least one object. The object comprises but is not limited to a person, an article, an information display area for human-computer interaction, a control, and the like. In practice, if the virtual image comprises a plurality of objects, all the objects may be determined as the target objects, or some of the objects may be determined as the target objects.

In some embodiments, the target area refers to an area where a cone formed with an apex being a center of an eye of a person or an exit pupil of the display module and a bottom being the object in the virtual image intersects with the light shielding structure. Alternatively, the target area refers to an area where a cone formed with an apex being a center of an eye of a person or an exit pupil of the display module and a bottom being the object in the virtual image intersects with the phase retardation device.

For example, if the virtual image displayed by the display module in the non-light transmitting period of a specific frame comprises a box, a target area corresponding to the box is determined based on a position of the box in the virtual image and the apex being the center of the eye of the person or the exit pupil of the display module. In the light transmitting period, the display module does not display the virtual image comprising the box. The light shielding unit in the target area is in the light shielding state, and the light shielding unit located outside the target area is in the light transmitting state. In the non-light transmitting period, the display module displays the virtual image comprising the box, and the light shielding structure is in the light shielding state. In other words, the light shielding unit in the target area corresponding to the box is in the light shielding state in the non-light transmitting period and the light transmitting period, and the light shielding unit located outside the target area corresponding to the box is in the light shielding state in the non-light transmitting period, and is in the light transmitting state in the light transmitting period. This can prevent a visual image of the real world that should be blocked by the box from being formed in the eyes of the person in the light transmitting period and remaining in the brain of the person, thereby causing a problem of an unauthentic display effect of the target object.

In some embodiments, the target object comprises a black object or an opaque object. The purpose of this setting is to implement realistic display of the black object or the opaque object.

A person skilled in the art may understand that for a determined AR head-mounted display device, a display position of each pixel in the display module on the lens is fixed. Before the display module displays a specific frame of virtual image, based on a driving signal for driving the display module to display the frame of virtual image, an area in the light shielding structure that is the target area corresponding to the frame of virtual image may be directly determined. Instead of determining, after the display module displays the frame of virtual image, an area in the light shielding structure that is the target area corresponding to the frame of virtual image.

Based on this, in some embodiments, in the light transmitting period, the processor obtains a control signal for the light shielding structure based on the driving signal, and sends the driving signal to the display module and the control signal to the light shielding structure, such that the display module displays a virtual image, and a light shielding unit in the light shielding structure that is located in the target area is in the non-light transmitting state, and a light shielding unit that is located outside the target area is in the light transmitting state.

Based on the foregoing technical solutions, in some embodiments, the lens further comprises a depolarization optical element, and the depolarization optical element is located on an ambient side of the light shielding structure.

FIG. 7 is a schematic diagram of a structure of another AR head-mounted display device according to some embodiments of the present disclosure. Referring to FIG. 7, a depolarization optical element 30 is located on an ambient side of a light shielding structure 10.

In some embodiments, the depolarization optical element comprises a depolarizer or a wave plate. Further, in response to the depolarization optical element comprising the wave plate, an optical axis of the wave plate forms a preset included angle with a light transmitting axis of the second polarization optical element. The reason for this setting is that light emitted from some display apparatuses such as a mobile phone screen, a television, and a display is linearly polarized light. When a user wears the AR head-mounted display device, if the depolarization optical element is not provided and a vibration direction of light emitted from the display apparatus is perpendicular to the light transmitting axis of the second polarization optical element, the light emitted from the display apparatus cannot pass through the light shielding structure in the AR head-mounted display device, and thus cannot enter the human eyes. In other words, after wearing the AR head-mounted display device, the user cannot watch display apparatuses such as the mobile phone screen, the television, and the display. By adding the depolarization optical element to the AR head-mounted display device, a polarization direction of linearly polarized light emitted from the display apparatuses such as the mobile phone screen, the television, and the display can be changed, or the linearly polarized light emitted from the display apparatuses such as the mobile phone screen, the television, and the display is converted into non-linearly polarized light (such as circularly polarized light or elliptically polarized light) or natural light, and then can pass through the light shielding structure and enter the human eyes, to ensure that after wearing the AR head-mounted display device, the user can watch the display apparatuses such as the mobile phone screen, the television, and the display.

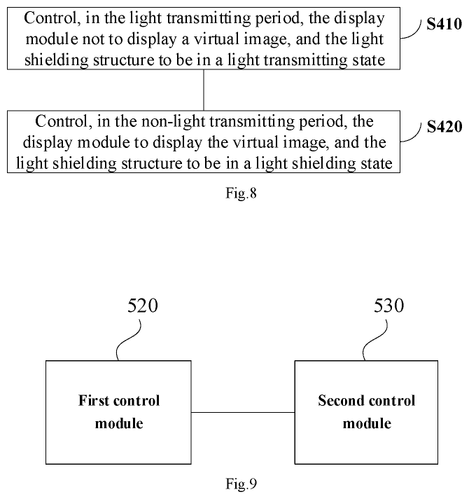

FIG. 8 is a flowchart of a control method of an AR head-mounted display device according to some embodiments of the present disclosure. The control method is applicable to the AR head-mounted display device provided in the embodiments of the present disclosure. Display time of one frame of the AR head-mounted display device comprises at least one light transmitting period and at least one non-light transmitting period, and the light transmitting period and the non-light transmitting period are performed alternately. Referring to FIG. 8, the method comprises the following steps S410 to S420.

In S410, in the light transmitting period, the display module is controlled not to display a virtual image, and the light shielding structure is controlled to be in a light transmitting state.

In S420, in the non-light transmitting period, the display module is controlled to display the virtual image, and the light shielding structure is controlled to be in a light shielding state.

Visual persistence refers to a phenomenon in which the vision generated by light on the retina is still retained for a period of time after the light stops acting. the display time of one frame comprises one light transmitting period and one non-light transmitting period. In the light transmitting period, since the light shielding structure is in the light transmitting state, the human eyes can observe the real world through the light shielding structure. Due to the effect of visual persistence, when the time reaches the non-light transmitting period, the visual image of the real world is still retained in the human brain. At the same time, in the non-light transmitting period, the display module displays the virtual image, and the human eyes can also see the virtual image displayed by the display module. The visual image formed by the virtual image is also retained in the human brain, so that the virtual image and the real world are superimposed in human perception.

In addition, because the display module does not display the virtual image in the light transmitting period, a visual image of the real world formed in the human eyes will not be disturbed by the virtual image displayed by the display module, so that the visual image of the real world is clearer in the human brain. In addition, other users (who are not the wearer of the AR head-mounted display device) cannot observe the virtual image displayed by the display module through the light shielding structure. In the non-light transmitting period, the light shielding structure is in the light shielding state, a visual image of the virtual image formed in the human eyes will not be disturbed by external ambient light, so that the virtual image has high visibility, and the visual image of the virtual image can be clearer in the human brain. In addition, light forming the virtual image cannot reach the eyes of other users (who are not the wearer of the AR head-mounted display device) through the light shielding structure, to avoid an adverse phenomenon of information leakage.

Therefore, the foregoing technical solution can improve visibility of the virtual image and the real world on the one hand, and can avoid an adverse phenomenon of information leakage caused by light for forming the virtual image being emitted to the outside on the other hand.

Further, the light shielding structure comprises a plurality of light shielding units arranged in an array, and a working state of each light shielding unit is independently adjustable; and the controlling, in the light transmitting period, the display module not to display a virtual image, and the light shielding structure to be in a light transmitting state comprises: determining a target area, where the target area is a display area of the display module on the lens; and in the light transmitting period, controlling a light shielding unit in the light shielding structure that is located in the target area to be in a non-light transmitting state, and a light shielding unit that is located outside the target area to be in a light transmitting state.

It should be noted that for the foregoing method embodiments, for the purpose of simple description, they are all expressed as a series of action combinations, but those skilled in the art should know that the present disclosure is not limited by the described action sequence, because according to the present disclosure, some steps can be performed in other orders or performed simultaneously. Secondly, those skilled in the art should also know that the embodiments described in the specification are all preferred embodiments, and the related actions and modules are not necessarily required by the present disclosure.

FIG. 9 is a schematic diagram of a structure of a control apparatus of an AR head-mounted display device according to some embodiments of the present disclosure. The control apparatus of the AR head-mounted display device provided in this embodiment of the present disclosure is applicable to the AR head-mounted display device provided in the embodiments of the present disclosure. Display time of one frame of the AR head-mounted display device comprises at least one light transmitting period and at least one non-light transmitting period, and the light transmitting period and the non-light transmitting period are performed alternately. Referring to FIG. 9, the control apparatus of the AR head-mounted display device specifically comprises:

a first control module 510, configured to control, in the light transmitting period, the display module not to display a virtual image, and the light shielding structure to be in a light transmitting state; and a second control module 520, configured to control, in the non-light transmitting period, the display module to display the virtual image, and the light shielding structure to be in a light shielding state.

Further, the light shielding structure comprises a plurality of light shielding units arranged in an array, and a light shielding effect of each light shielding unit is independently adjustable; and the first control module is configured to: determine a target area, where the target area is a display area of the display module on the lens; and in the light transmitting period, control a light shielding unit in the light shielding structure that is located in the target area to be in a non-light transmitting state, and a light shielding unit that is located outside the target area to be in a light transmitting state.

The control apparatus of the AR head-mounted display device provided in this embodiment of the present disclosure can perform steps of the control method of the AR head-mounted display device provided in the method embodiments of the present disclosure, and has the same or corresponding beneficial effects, which will not be described again here.

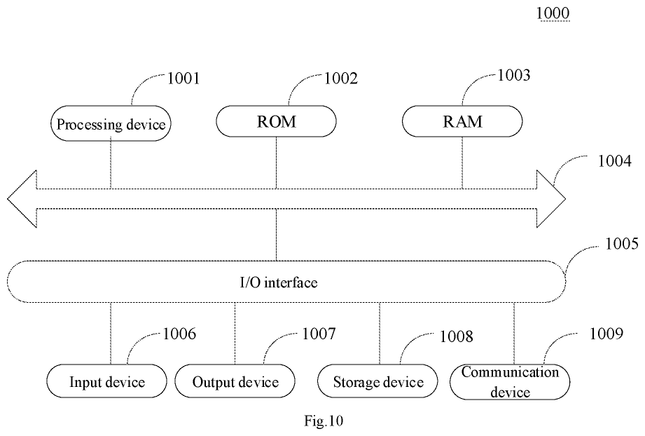

FIG. 10 is a schematic diagram of a structure of an electronic device according to an embodiment of the present disclosure. Referring to FIG. 10 below, a schematic diagram of a structure of an electronic device 1000 suitable for implementing the embodiments of the present disclosure is shown. The electronic device 1000 in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 10 is merely an example, and should not impose any limitation on the function and scope of use of the embodiments of the present disclosure.

As shown in FIG. 10, the electronic device 1000 may include a processing apparatus (for example, a central processing unit, a graphics processing unit, and the like) 1001 that may perform various appropriate actions and processing in accordance with a program stored in a read-only memory (ROM) 1002 or a program loaded from a storage apparatus 1008 into a random access memory (RAM) 1003 to implement the control method of the AR head-mounted display device of the embodiment described in the present disclosure. The RAM 1003 further stores various programs and information required for the operation of the electronic device 1000. The processing apparatus 1001, the ROM 1002, and the RAM 1003 are connected to each other through a bus 1004. An input/output (I/O) interface 1005 is also connected to the bus 1004.

Generally, the following apparatuses may be connected to the I/O interface 1005: an input apparatus 1006 including, for example, a touch screen, a touchpad, a keyboard, a mouse, a camera, a microphone, an accelerometer, and a gyroscope; an output apparatus 1007 including, for example, a liquid crystal display (LCD), a speaker, and a vibrator; the storage apparatus 1008 including, for example, a tape and a hard disk; and a communication apparatus 1009. The communication apparatus 1009 may allow the electronic device 1000 to perform wireless or wired communication with other devices to exchange information. Although FIG. 10 shows the electronic device 1000 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure comprises a computer program product, which comprises a computer program carried on a non-transitory computer-readable medium, where the computer program comprises program code for performing the method shown in the flowchart, so as to implement the control method of the AR head-mounted display device described above. In such an embodiment, the computer program may be downloaded from a network through the communication apparatus 1009 and installed, installed from the storage apparatus 1008, or installed from the ROM 1002. When the computer program is executed by the processing apparatus 1001, the above-mentioned functions defined in the method of the embodiment of the present disclosure are performed.

It should be noted that the foregoing computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include an information signal propagated in a baseband or as a part of a carrier, the information signal carrying computer-readable program code. The propagated information signal may be in various forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

In some implementations, the client and the server may communicate using any known or future-developed network protocol such as a hypertext transfer protocol (HTTP), and may be connected to digital information communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any known or future-developed network.

The foregoing computer-readable medium may be contained in the foregoing electronic device. Alternatively, the computer-readable medium may exist independently, without being assembled into the electronic device.

The computer-readable medium carries one or more programs, and when the one or more programs are executed by the electronic device, the electronic device is caused to:
control, in the light transmitting period, the display module not to display a virtual image, and the light shielding structure to be in a light transmitting state; and
control, in the non-light transmitting period, the display module to display the virtual image, and the light shielding structure to be in a light shielding state.

In some embodiments, when the one or more programs are executed by the electronic device, the electronic device may further perform other steps described in the foregoing embodiments.

The computer program code for performing the operations of the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving the remote computer, the remote computer may be connected to the computer of the user through any type of network, including a local area network (LAN) or a wide area network (WAN), or may be connected to an external computer (for example, connected through the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit itself in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, the machine-readable medium may be a tangible medium, which may contain or store a program for use by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

According to one or more embodiments of the present disclosure, the present disclosure provides an electronic device, including:
one or more processors;
a memory configured to store one or more programs; and
wherein the one or more programs, when executed by the one or more processors, cause the one or more processors to implement the control method of the AR head-mounted display device according to any one of the present disclosure.

According to one or more embodiments of the present disclosure, the present disclosure provides a computer-readable storage medium having a computer program stored thereon, where when the program is executed by a processor, the control method of the AR head-mounted display device according to any one of the present disclosure is implemented.

An embodiment of the present disclosure further provides a computer program product, where the computer program product comprises a computer program or instructions, and when the computer program or instructions are executed by a processor, the control method of the AR head-mounted display device described above is implemented.

It should be noted that in this document, relational terms such as “first” and “second” are only used to distinguish one entity or operation from another entity or operation, and do not necessarily require or imply any actual relationship or order between these entities or operations. Moreover, the terms “include”, “contain” or any other variants thereof are intended to cover non-exclusive inclusion, so that a process, method, article or device including a series of elements not only comprises those elements, but also comprises other elements not explicitly listed, or further comprises elements inherent to such process, method, article or device. Without more restrictions, the element defined by the sentence “including a . . . ” does not exclude the presence of additional identical elements in the process, method, article or device that comprises the element.

The foregoing descriptions are merely specific implementations of the present disclosure, which enables a person skilled in the art to understand or implement the present disclosure. Various modifications to these embodiments will be apparent to those skilled in the art, and the general principles defined herein may be implemented in other embodiments without departing from the spirit or scope of the present disclosure. Therefore, the present disclosure will not be limited to the embodiments described herein, but is to be consistent with the widest scope consistent with the principles and novel features disclosed herein.

1. An Augmented reality (AR) head-mounted display device, comprising: a display module, a lens, and a processor, wherein:
the lens comprises an optical waveguide structure and a light shielding structure that are stacked;
the light shielding structure is located on an ambient side of the optical waveguide structure away from eyes of a user;
the optical waveguide structure is configured to couple light emitted from the display module to the eyes of the user and working states of the light shielding structure comprise a light shielding state and a light transmitting state; and
the processor is electrically connected to the light shielding structure, and configured to control the light shielding structure to switch between the light shielding state and the light transmitting state.

2. The AR head-mounted display device according to claim 1, wherein:
display time of one frame of the AR head-mounted display device comprises at least one light transmitting period and at least one non-light transmitting period, and the light transmitting period and the non-light transmitting period are performed alternately;
in the light transmitting period, the display module does not display a virtual image, and the light shielding structure is in the light transmitting state; and
in the non-light transmitting period, the display module displays the virtual image, and the light shielding structure is in the light shielding state.

3. The AR head-mounted display device according to claim 1, wherein the light shielding structure comprises a first polarization optical element, a phase retardation device, and a second polarization optical element that are stacked in a direction from an eye side to the ambient side.

4. The AR head-mounted display device according to claim 3, wherein:
both the first polarization optical element and the second polarization optical element are polarizers; or
both the first polarization optical element and the second polarization optical element are polarization light splitting films; or
the first polarization optical element is a polarization light splitting film, and the second polarization optical element is a polarizer; or
the first polarization optical element is a polarizer, and the second polarization optical element is a polarization light splitting film.

5. The AR head-mounted display device according to claim 3, wherein polarization directions of the first polarization optical element and the second polarization optical element are parallel or perpendicular.

6. The AR head-mounted display device according to of claim 2, wherein the light shielding structure comprises a plurality of light shielding units arranged in an array, and a working state of each light shielding unit is independently adjustable; and
in the light transmitting period, a light shielding unit in the light shielding structure that is located in a target area is in a non-light transmitting state, and a light shielding unit that is located outside the target area is in a light transmitting state; where the target area is a display area of the display module on the lens.

7. The AR head-mounted display device according to claim 1, wherein the lens further comprises a depolarization optical element; and
the depolarization optical element is located on an ambient side of the light shielding structure.

8. The AR head-mounted display device according to claim 4, wherein in response to at least one of the first polarization optical element and the second polarization optical element being a polarization light splitting film, the optical waveguide structure is a waveguide lens.

9. The AR head-mounted display device according to claim 7, wherein the depolarization optical element comprises a depolarizer or a wave plate, and in response to the depolarization optical element comprising the wave plate, an optical axis of the wave plate forms a preset included angle with a light transmitting axis of the second polarization optical element.

10. A control method of an AR head-mounted display device, wherein the control method is applicable to the AR head-mounted display device according to claim 1, display time of one frame of the AR head-mounted display device comprises at least one light transmitting period and at least one non-light transmitting period, and the light transmitting period and the non-light transmitting period are performed alternately, and the control method comprises:
controlling, in the light transmitting period, the display module not to display a virtual image, and the light shielding structure to be in a light transmitting state; and
Controlling, in the non-light transmitting period, the display module to display the virtual image, and the light shielding structure to be in a light shielding state.

11. The control method according to claim 10, wherein the light shielding structure comprises a plurality of light shielding units arranged in an array, and a working state of each light shielding unit is independently adjustable, and the controlling, in the light transmitting period, the display module not to display a virtual image, and the light shielding structure to be in a light transmitting state comprises:
determining a target area, where the target area is a display area of the display module on the lens; and
controlling, in the light transmitting period, a light shielding unit in the light shielding structure that is located in the target area to be in a non-light transmitting state, and a light shielding unit that is located outside the target area to be in a light transmitting state.

12. (canceled)

13. An electronic device, comprises:
one or more processors;
a storage apparatus, configured to store one or more programs,
wherein the one or more programs, when executed by the one or more processors, cause the one or more processors to implement the control method according to claim 10.

14. A non-transitory computer-readable storage medium having a computer program stored thereon, wherein when the program is executed by a processor, causes the processor to implement the control method according to claim 10.

15. A computer program, comprising: instructions that, when executed by a processor, cause the processor to implement the control method according to claim 10.

16. The electronic device according to claim 11, wherein the one or more programs, when executed by the one or more processors, cause the one or more processors to implement the control method according to claim 11.

17. The non-transitory computer-readable storage medium having a computer program stored thereon, wherein when the program is executed by a processor, causes the processor to implement the control method according to claim 11.

18. The computer program, comprising: instructions that, when executed by a processor, cause the processor to implement the control method according to claim 11.

19. The AR head-mounted display device according to claim 2, wherein the light shielding structure comprises a first polarization optical element, a phase retardation device, and a second polarization optical element that are stacked in a direction from an eye side to the ambient side.

20. The AR head-mounted display device according to claim 4, wherein polarization directions of the first polarization optical element and the second polarization optical element are parallel or perpendicular.

21. The AR head-mounted display device according to claim 2, wherein the lens further comprises a depolarization optical element; and
the depolarization optical element is located on an ambient side of the light shielding structure.
